(19) United States
(12) Patent Application Publication
(10) Pub. No.: US 2013/0232998 A1
(43) Pub. Date: Sep. 12, 2013

(54) VERTICAL STORAGE RACK FOR COLD STORAGE UNITS

(71) Applicants: Dennis D. Ward, Vincent, OH (US); James O. McDougle, Stockport, OH (US)

(72) Inventors: Dennis D. Ward, Vincent, OH (US); James O. McDougle, Stockport, OH (US)

(73) Assignee: THERMO FISHER SCIENTIFIC (ASHEVILLE) LLC, Asheville, NC (US)

(21) Appl. No.: 13/488,617

(22) Filed: Jun. 5, 2012

Related U.S. Application Data
(60) Provisional application No. 61/609,589, filed on Mar. 12, 2012.

(51) Int. Cl. F17C 3/00; B21D 31/00; B23P 11/00; F25D 25/02

(52) U.S. Cl. 62/51.1; 211/85.17; 72/379.2; 29/428; 29/525.14

(57) ABSTRACT

A cold storage unit such as a cryogenic dewar includes a tank with an opening, a storage space communicating with the opening, and a pool for liquid nitrogen positioned adjacent the storage space. The storage space receives a plurality of storage racks, each including a rack body with a rear wall and first and second sidewalls extending from the rear wall. The storage rack also includes a plurality of shelves, each shelf defined by a first lip punched from the first sidewall and a second lip punched from the second sidewall, the first and second lips being bent towards one another and spaced from one another. The shelves minimize the material and weight used in manufacturing the storage rack. Additionally, the storage rack is assembled with minimal spot welding required.

### FIELD OF THE INVENTION

The present invention relates generally to storage racks and, more particularly, to storage racks configured for use in cold storage units such as cryogenic dewars for storing samples at about −180° C., or lower.

### BACKGROUND OF THE INVENTION

Cold storage units such as freezers and dewars are used for various purposes, including the storage of biological samples over short and long periods of time. For example, biological materials for transplantation such as blood, tissue, or plasma may require storage for short periods of time before use. In another example, biological cells such as DNA samples may be stored for longer periods of time. Conventional cold storage units may be cooled by mechanical cooling circuits or by liquid nitrogen (“LN2”).

In a known cold storage unit referred to as a LN2 cryogenic dewar, the dewar includes a tank having a vacuum-insulated shell enclosing a pool of liquid nitrogen and a storage space located above the pool of liquid nitrogen (which boils at −196° C.). The storage space is usually configured to receive a plurality of storage racks for containing boxes of vials or other containers holding biological samples. The tank includes an insulated lid or plug at an opening in the top to provide selective access into the storage space for retrieval and replacement of the storage racks. In order to limit the exposure of the liquid nitrogen and storage space to the external environment, the opening in the tank is sized smaller than the storage space and each storage rack is rotatable or moveable into alignment with the opening for removal. As a result, storage racks for LN2 cryogenic dewars are generally oriented as a vertical storage rack that can be lifted or lowered through the opening at the top of the tank.

The vertical storage racks used with LN2 cryogenic dewars generally include multiple shelves for holding vertically-stacked storage boxes. The storage racks are manufactured from stainless steel and the shelves are spot welded into position with a plurality of side walls and/or runners to ensure sufficient structural strength and rigidity of the storage rack during use in the cryogenic dewar and during movement into and out of the cryogenic dewar. The manufacturing process for these conventional storage racks is highly time-consuming and requires skill-intensive labor. Additionally, when fully loaded with storage boxes filled with vials, each storage rack defines a relatively heavy weight that may be difficult to lift into and out of the opening at the top of the tank.

There is a need, therefore, for a storage rack for use with LN2 cryogenic dewars and other cold storage units that improves the manufacturing process while providing improved performance compared to conventional storage racks.

### SUMMARY OF THE INVENTION

In one embodiment according to the present invention, a storage rack for holding storage boxes within a cold storage unit includes a rack body including a rear wall and first and second opposed sidewalls extending from the rear wall. A plurality of shelves is defined by a series of first lips punched from the first sidewall and a series of second lips punched from the second sidewall. The first and second lips are bent towards each other and spaced from each other. The storage rack also includes a handle supported by the rack body and configured to support the storage rack during movement into and out of the cold storage unit. Forming the plurality of shelves by punching and bending lips from the first and second sidewalls saves material and weight of the storage rack while simplifying manufacturing of the storage rack.

In one aspect, the storage rack also includes a top wall coupled to the first and second sidewalls and a bottom wall coupled to the first and second sidewalls. The plurality of shelves is located between the top wall and the bottom wall. A rack reinforcement plate is engaged with the first and second lips of one of the shelves. In some embodiments, the rack reinforcement plate extends from the first sidewall to the second sidewall. The rack reinforcement plate is spot welded to the first and second lips of the corresponding shelf.

In another aspect, the rack body includes a plurality of apertures cut from each of the rear wall and the first and second sidewalls. In yet another aspect, the handle includes an upper end configured to be positioned adjacent an opening of the cold storage unit when the storage rack is located within a storage space of the vessel. The handle also includes a lower end coupled to the rack body and an elongate intermediate portion extending between the upper and lower ends. The upper end and the intermediate portion define a circular cross section, while the lower end defines a flattened rectangular cross section so that the lower end may be spot welded to the rack body. As a result, the storage rack is manufactured by a plurality of punching and bending steps that may be automated with a minimized number of spot welds performed by a skilled worker. A plurality of the storage racks may be used with a cold storage unit such that a pool of liquid nitrogen within the vessel maintains the temperature of any biological samples within the storage boxes at a low temperature such as about −180° C.

According to another embodiment, a method of manufacturing a storage rack for holding storage boxes within a cold storage unit includes providing a flat sheet sized to define a rack body having a rear wall and first and second sidewalls. The method also includes punching a plurality of first lips from the flat sheet at the first sidewall and bending the first lips generally perpendicular to the flat sheet. A plurality of second lips is punched from the flat sheet at the second sidewall and bent generally perpendicular to the flat sheet. The method also includes bending the flat sheet to form a rack body with the first and second sidewalls extending from the rear wall such that the plurality of first lips and the plurality of second lips extend towards one another and are spaced from each other. The method further includes coupling a handle to the top wall. The first and second lips on the rack body collectively define a plurality of shelves.

In one aspect, the method also includes stamping a plurality of apertures from the flat sheet at the rear wall and at the first and second sidewalls to reduce material in the storage rack. A rack reinforcement plate extending from the first sidewall to the second sidewall may also be engaged with the first and second lips of one of the shelves. The flat sheet and rack body may further include a top wall and a bottom wall, and the method in these circumstances also includes bending the top and bottom walls and coupling the top and bottom walls to each of the first and second sidewalls. The rack reinforcement plate, the handle, and the top and bottom walls are each spot welded into final positions in the storage rack.

These and other objects and advantages of the present invention will become more readily apparent during the following detailed description taken in conjunction with the drawings herein.

### BRIEF DESCRIPTION OF THE DRAWINGS

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 is a perspective view of a LN2 cryogenic dewar including a vertical storage rack according to an exemplary embodiment of the present invention, with the storage rack being inserted into the dewar.

FIG. 2 is a perspective view of the vertical storage rack of FIG. 1 located outside the LN2 cryogenic dewar.

FIG. 3 is a front view of the vertical storage rack of FIG. 2.

FIG. 4 is a side view of the vertical storage rack of FIG. 2.

FIG. 5 is a top view of a flat sheet blank used to manufacture the vertical storage rack of FIG. 2.

FIG. 6 is a perspective view of a vertical storage rack according to another embodiment of the present invention.

### DETAILED DESCRIPTION

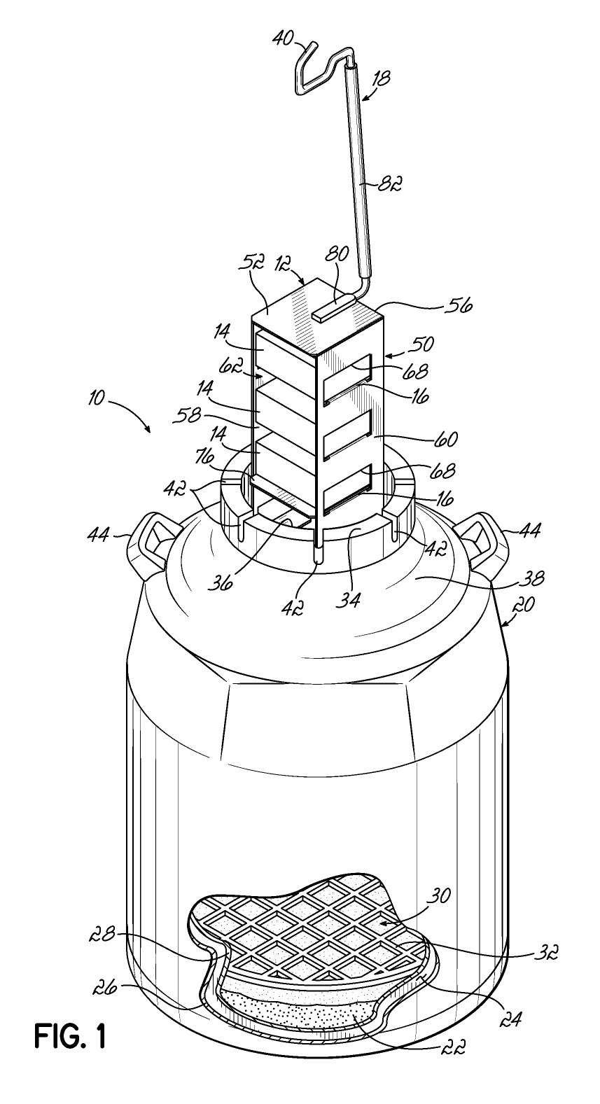

With reference to the figures, and more specifically to FIGS. 1 through 4, a liquid nitrogen cryogenic dewar 10 including an exemplary vertical storage rack 12 according to one embodiment of the present invention is illustrated. Although the term “cryogenic dewar” is used throughout the specification when referring to this embodiment of the invention, it will be understood that this and other embodiments of the vertical storage rack 12 disclosed herein may be used with any type of refrigerator, freezer and cryogenic vessel (collectively referred to hereafter as “cold storage units”), such as, in one example, a chest freezer. In addition, it will be understood that the cryogenic dewar 10 may be cooled by liquid nitrogen, by a mechanical cooling circuit, or by any other known cooling methods. The vertical storage rack 12 is shaped and sized to receive a column or stack of cryogenic storage boxes 14 (alternatively a column or stack of “micro plates”) as shown in FIG. 1. The storage boxes 14 typically contain a grid (not shown) or other internal structure for receiving and orienting a plurality of vials or tubes (not shown) filled with biological samples in an array. However, the storage boxes 14 may be sized to receive other types of containers for biological samples. In the exemplary embodiment, each of the storage boxes 14 is supported on one of a plurality of shelves 16 located on the storage rack 12. The storage rack 12 also includes an elongate handle 18 for supporting the storage rack 12 during movement into and out of the cryogenic dewar 10, as shown in FIG. 1.

With continued reference to FIG. 1, the cryogenic dewar 10 includes a tank 20 configured to contain a pool of liquid nitrogen 22 and a plurality of the vertical storage racks 12. The tank 20 includes double-walled insulation that defines a vacuum space 24 between an outer tank wall 26 and an inner tank wall 28. The vacuum space 24 limits the transfer of environmental heat into a storage space 30 located within the inner tank wall 28. The storage space 30 extends from a bottom end 32 (shown as grating 32) adjacent the pool of liquid nitrogen 22 to a top end 34 including an opening 36 in outer and inner tank walls 26, 28. The opening 36 is sized smaller than the storage space 30 such that the tank 20 defines a narrowing neck portion 38 adjacent the opening 36. The opening 36 is also sized to be just large enough to receive the storage rack 12 as the storage rack 12 is moved into and out of the cryogenic dewar 10, as shown in FIG. 1. To this end, the exposure of the storage space 30 and the pool of liquid nitrogen 22 to the external environment is limited during removal or insertion of a storage rack 12.

In use, after the storage rack 12 is fully inserted into the center of the storage space 30, the handle 18 may be used to push the storage rack 12 towards the periphery of the storage space 30. In the illustrated embodiment, an upper end 40 of the handle 18 engages with one of a plurality of handle slots 42 located around the opening 36 when the storage rack 12 is moved to the periphery of the storage space 30. These handle slots 42 enable each handle 18 to be accessed from the opening 36. Thus, the storage space 30 receives a plurality of storage racks 12 (for example, four, six, eight, or some other number) in the periphery of the storage space 30, each of which may be independently accessed by moving the storage rack 12 to the center of the storage space 30 and then pulling the storage rack 12 out through the opening 36. The tank 20 also includes tank handles 44 adjacent the neck portion 38 for moving the cryogenic dewar 10 when necessary and a lid (not shown) configured to close the opening 36 and seal the storage space 30 from the external environment when the storage racks 12 do not need to be moved into or out of the cryogenic dewar 10.

During operation, the liquid nitrogen 22 boils off over time at a temperature of about −196° C. to maintain the temperature within the storage space 30 at a low cryogenic temperature, thereby keeping the biological samples on the storage racks 12 at a desired storage temperature. For example, the biological samples may be maintained at a desired storage temperature of about −180° C. It will be understood that the dewar 10 may include additional monitoring sensors and alarms that indicate when the level of liquid nitrogen is low and needs to be replenished to maintain the desired storage temperature within the storage space 30.

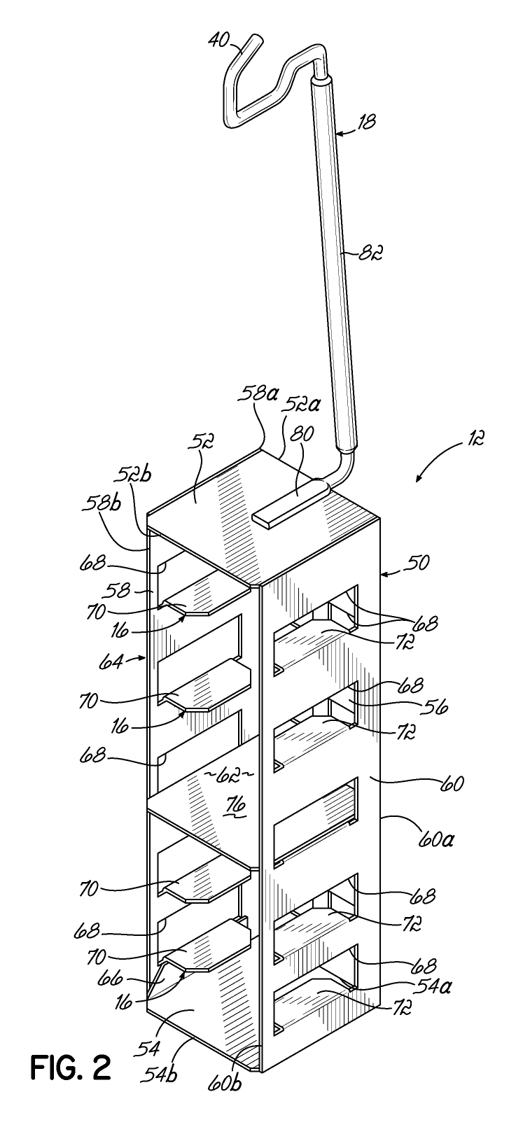

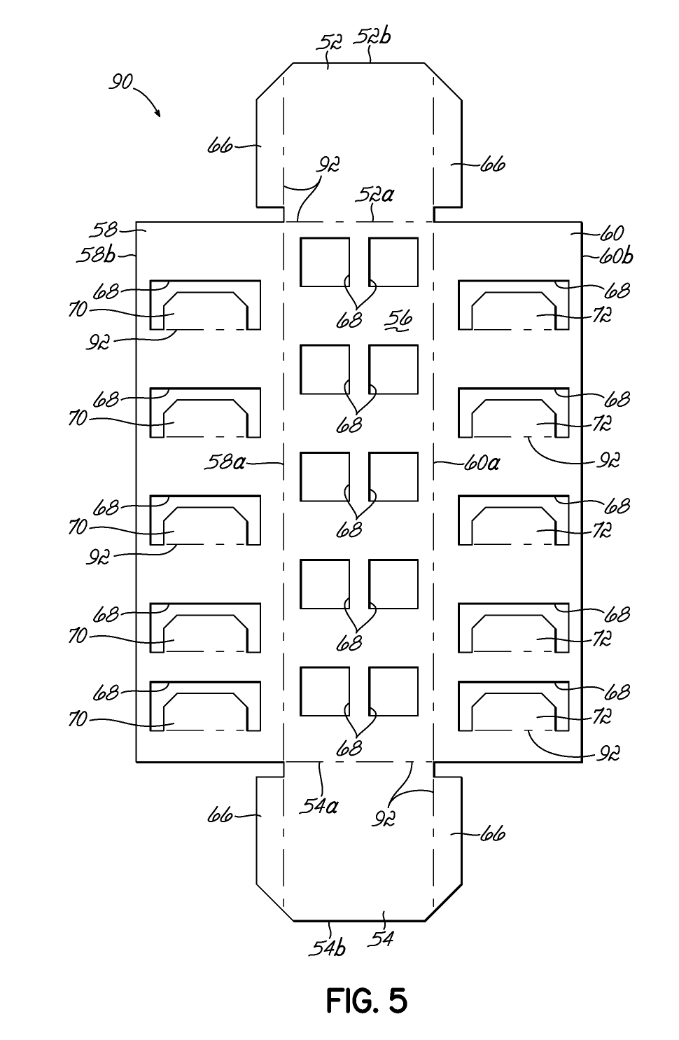

Details of the vertical storage rack 12 according to this embodiment are more clearly shown in FIGS. 2 through 4. According to one embodiment, the vertical storage rack 12 includes a generally rectangular or C-shaped rack body 50 with a top wall 52 and a bottom wall 54. The various walls of the rack body 50 may be collectively formed from a flat sheet blank 90 of type 201 stainless steel shown in FIG. 5 and described in further detail below with reference to a method of manufacturing the storage rack 12. Returning to FIGS. 2 through 4, the C-shaped rack body 50 also includes a rear wall 56 and first and second opposed sidewalls 58, 60 extending in generally parallel relation from the rear wall 56. More particularly, the first and second sidewalls 58, 60 each extend from a rear edge 58a, 60a connected to the rear wall 56 to a front edge 58b, 60b positioned away from the rear wall 56.

Accordingly, the rack body 50 partially encloses a rectangular space 62 configured to receive storage boxes through an open front 64 of the rack body 50. The top wall 52 and the bottom wall 54 are coupled to the first and second sidewalls 58, 60 to bound the rectangular space 62 at ends of the rack body 50. For example, the top wall 52 and the bottom wall 54 each include connection tabs 66 that are bent from the top and bottom walls 52, 54 so that the connection tabs 66 may be spot welded to the first and second sidewalls 58, 60. The top wall 52 and the bottom wall 54 each extend from respective rear edges 52a, 54a connected to the rear wall 56 to front edges 52b, 54b located between the front edges 58b, 60b of the first and second sidewalls 58, 60. In this regard, the set of front edges 52b, 54b, 58b, 60b of the top wall 52, bottom wall 54, and first and second sidewalls 58, 60 collectively defines the open front 64 of the rack body 50. It will be understood that the top wall 52 and the bottom wall 54, if present, may be connected to the rear wall 56 and the first and second sidewalls 58, 60 in other known manners in alternative embodiments within the scope of the present invention.

The vertical storage rack 12 also includes a plurality of apertures 68 cut from the rear wall 56 and from the first and second sidewalls 58, 60. These apertures 68 reduce the total amount of stainless steel material used to form the vertical storage rack 12. The apertures 68 located along the first and second sidewalls 58, 60 are shaped to produce respective first and second lips 70, 72 that may be bent inwardly towards the rectangular space 62 from the first and second sidewalls 58, 60. To this end, the first and second sidewalls 58, 60 include a plurality of first and second lips 70, 72 that are punched from the remainder of the first and second sidewalls 58, 60 and bent or folded generally perpendicular to the first and second sidewalls 58, 60. In the assembled state shown in FIGS. 2 through 4, these first and second lips 70, 72 produce a plurality of shelves 16 within the vertical storage rack 12 and located between the top wall 52 and the bottom wall 54.

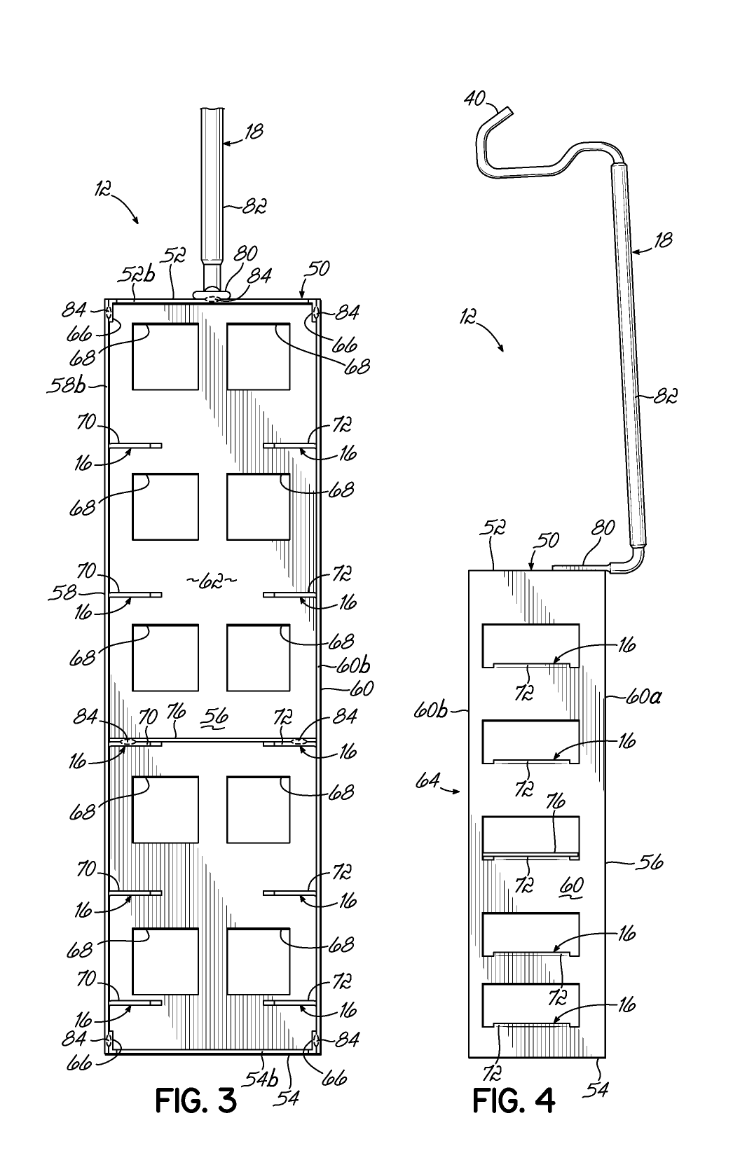

The plurality of apertures 68 and the plurality of shelves 16 are shown in further detail in FIGS. 3 and 4. Although each of the apertures 68 defines a generally rectangular shape in the illustrated embodiment, it will be appreciated that any shape may be cut or punched from the rear wall 56 and first and second sidewalls 58, 60 in other embodiments of the present invention. Each of the shelves 16 is defined by a pair of first and second lips 70, 72 extending inwardly from the corresponding first and second sidewalls 58, 60. As clearly shown in FIG. 3, the first and second lips 70, 72 are spaced from one another in the final assembled state of the vertical storage rack 12. Consequently, each of the shelves 16 consists of only first and second lips 70, 72 that collectively require significantly less stainless steel material than conventional shelves that extend entirely across the space 62 between first and second sidewalls 58, 60. However, the first and second lips 70, 72 are sized large enough to reliably support storage boxes 14 filled with vials or containers of biological samples or other materials without buckling. In addition to using less stainless steel material, the plurality of shelves 16 is advantageously manufactured by a machine press or similar mechanism that punches and bends the first and second lips 70, 72 from the first and second sidewalls 58, 60 rather than requiring skilled laborers to spot weld separate shelves into position within the rack body 50.

In the embodiment shown in FIGS. 2 through 4, the storage rack 12 includes five shelves 16. However, it will be understood that the relative size, spacing, and number of shelves 16 may be modified in other embodiments to accommodate storage boxes 14 having different sizes. In embodiments of the storage rack 12 with four or more shelves 16 such as the exemplary embodiment illustrated, a structural reinforcement located at an intermediate area between the top and bottom walls 52, 54 may be desirable to maintain the rigidity of the rack body 50 along the length thereof. To this end, the storage rack 12 also includes a rack reinforcement plate 76 engaged with or coupled to the first and second lips 70, 72 of one of the shelves 16. The rack reinforcement plate 76 is spot welded to the first and second lips 70, 72 in one example, although an alternative method of connection between these elements may be used without departing from the scope of the present invention. In one embodiment, the rack reinforcement plate 76 extends from the first sidewall 58 to the second sidewall 60 to add structural support and rigidity to an intermediate portion of the rack body 50. The rack reinforcement plate 76 is also formed from a thin sheet of stainless steel such that the reinforcement plate 76 does not add significant material weight to the storage rack 12 and also does not significantly impact the storage capacity within the rectangular space 62.

Once the rack body 50 of the storage rack 12 has been folded and assembled as discussed above, the handle 18 is connected to the top wall 52 of the storage rack 12. In this regard, the handle 18 of this embodiment is shown in further detail in FIGS. 2 through 4 and includes a lower end 80 configured to be coupled to the rack body 50 at the top wall 52, the upper end 40, and an elongate intermediate portion 82 extending between the upper end 40 and the lower end 80. The upper end 40 is defined by a rod-shaped or circular cross section member of stainless steel bent into a hook shape for engagement with the handle slots 42 at the opening 36 of the tank 20. The intermediate portion 82 is also defined by a circular cross section member, although the intermediate portion 82 may be formed from a fiberglass material or similar material having lighter weight than stainless steel. The lower end 80 is formed from stainless steel and defines a flattened generally rectangular cross section as most clearly shown in FIG. 3. The flattened cross section of the lower end 80 advantageously provides a relatively large surface for connection to the top wall 52 by spot welding rather than by tack welding or other methods. With particular reference to FIG. 3, the plurality of spot welds 84 used to couple the handle 18 to the top wall 52 and used to couple the elements of the rack body 50 and rack reinforcement plate 76 together are schematically shown. The number of spot welds 84 has been minimized to reduce the time and skill-intensive labor necessary to manufacture the storage rack 12.

Thus, the vertical storage rack 12 of the exemplary embodiment is produced by the following manufacturing method. A flat sheet blank 90 (hereinafter “flat sheet” 90) sized to define the rear wall 56, the first and second sidewalls 58, 60, the top wall 52, and the bottom wall 54 is provided as shown in FIG. 5. The flat sheet 90 is machined such as by punching or stamping to cut the plurality of apertures 68 into the rear wall 56 and the first and second sidewalls 58, 60. From the state shown in FIG. 5, the first and second lips 70, 72 are punched and bent from the flat sheet 90 to be generally perpendicular to the flat sheet 90. The first and second lips 70, 72 are bent along the bend lines 92 shown in phantom line form in FIG. 5. It will be understood that the bend lines 92 may be scored on the flat sheet 90 prior to bending, although such scoring is not necessary in all embodiments of the present invention. The flat sheet 90 is then further bent along the remaining bend lines 92 (including the rear edges 52a, 54a, 58a, 60a of the top wall 52, bottom wall 54, and first and second sidewalls 58, 60) to form the generally rectangular shape of the vertical storage rack 12.

After these portions of the flat sheet 90 are bent into position, the connection tabs 66 of the top and bottom walls 52, 54 are spot welded to the first and second sidewalls 58, 60. In embodiments including a rack reinforcement plate 76, the rack reinforcement plate 76 is then inserted into position and spot welded to the corresponding first and second lips 70, 72 of the shelf 16. The handle 18, which has been separately manufactured, is then coupled to the top wall 52 by spot welding the flattened lower end 80 of the handle 18 onto the top wall 52 of the vertical storage rack 12. As a result, the vertical storage rack 12 is manufactured with a minimal number of required spot welds and a minimized amount of stainless steel material. Accordingly, the overall manufacturing time is reduced and the weight of the storage rack 12 is also reduced.

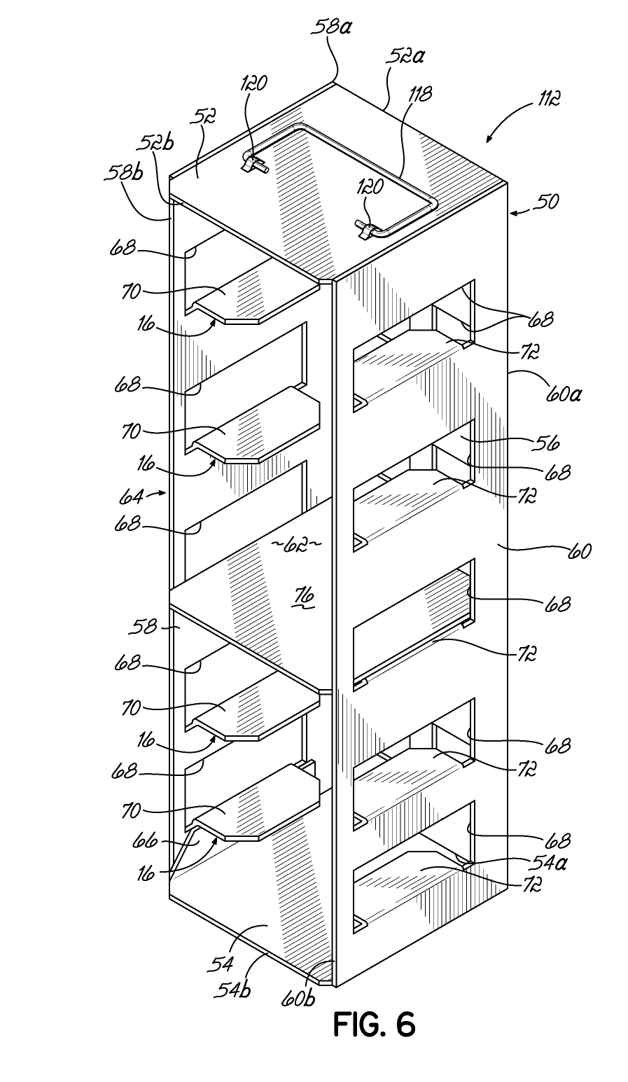

An alternative embodiment of the vertical storage rack 112 is shown in FIG. 6. In this embodiment, the vertical storage rack 112 includes substantially all of the elements previously described with reference to FIGS. 1 through 4 with the exception of the handle 18, and these elements (rack body 50, top wall 52, bottom wall 54, shelves 16, etc.) have been labeled with the same reference numbers without further description below. Instead of the elongate handle 18 used with the previous embodiment, the vertical storage rack 112 of FIG. 6 includes a foldable wire handle 118 coupled to the top wall 52 at a pair of pivot joints 120. The wire handle 118 is freely pivotable between the folded position shown in FIG. 6 and an unfolded position (not shown) in which the wire handle 118 may be gripped for moving the storage rack 112 into and out of a corresponding cold storage unit. For example, in embodiments of a cryogenic dewar with an opening along the periphery of the tank, the wire handle 118 may be used to enable rotatable movement of the plurality of storage racks 112 into and out of alignment with the opening in the tank so that each storage rack 112 is independently removable. However, the vertical storage rack 112 of this embodiment is most advantageously used with chest freezers and similar types of cold storage units. To this end, it will be understood that this embodiment of the vertical storage rack 112 may also be used with the cryogenic dewar 10 of the previously-described embodiment and other cold storage units without departing from the scope of the present invention.

While the present invention has been illustrated by a description of exemplary embodiments and while these embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit or scope of applicant's general inventive concept.

What is claimed is:

1. A storage rack for holding storage boxes within a cold storage unit, comprising:
a rack body including a rear wall and first and second opposed sidewalls extending from the rear wall;
a plurality of shelves, each of the shelves defined by a first lip punched from the first sidewall and a second lip punched from the second sidewall, the first and second lips being bent towards each other and spaced from each other; and
a handle supported by the rack body and configured to support the storage rack during movement into and out of the cold storage unit.

2. The storage rack of claim 1, wherein the rack body further comprises:
a top wall coupled to the first and second sidewalls; and
a bottom wall coupled to the first and second sidewalls, wherein the plurality of shelves are located between the top wall and the bottom wall.

3. The storage rack of claim 1, further comprising:
a rack reinforcement plate engaging the first and second lips of one of the plurality of shelves.

4. The storage rack of claim 3, wherein the rack reinforcement plate is spot welded to the first and second lips of the one shelf.

5. The storage rack of claim 3, wherein the rack reinforcement plate extends from the first sidewall to the second sidewall.

6. The storage rack of claim 1, wherein the rack body includes a plurality of apertures cut from each of the rear wall and the first and second sidewalls.

7. The storage rack of claim 1, wherein the cold storage unit includes a tank with a storage space and an opening at a top end of the storage space, and wherein the handle further comprises:
an upper end configured to be positioned adjacent the opening when the storage rack is located within the storage space;
a lower end coupled to the rack body; and
an elongate intermediate portion extending between the upper end and the lower end,
wherein the upper end and the intermediate portion define a circular cross section and the lower end defines a flattened generally rectangular cross section such that the lower end is spot welded to the rack body.

8. A cold storage unit for storing a plurality of storage boxes, comprising:
a tank including a storage space with a top end defining an opening and a bottom end positioned adjacent a pool configured to contain liquid nitrogen; and
a plurality of storage racks inserted into the storage space through the opening, each storage rack comprising:
a rack body including a rear wall and first and second opposed sidewalls extending from the rear wall;
a plurality of shelves, each of the shelves defined by a first lip punched from the first sidewall and a second lip punched from the second sidewall, the first and second lips being bent towards each other and spaced from each other; and
a handle supported by the rack body and configured to support the storage rack during movement into and out of the cold storage unit.

9. The cold storage unit of claim 8, wherein the rack body further comprises:
a top wall coupled to the first and second sidewalls; and
a bottom wall coupled to the first and second sidewalls, wherein the plurality of shelves are located between the top wall and the bottom wall.

10. The cold storage unit of claim 8, further comprising:
a rack reinforcement plate engaging the first and second lips of one of the plurality of shelves.

11. The cold storage unit of claim 10, wherein the rack reinforcement plate is spot welded to the first and second lips of the one shelf.

12. The cold storage unit of claim 10, wherein the rack reinforcement plate extends from the first sidewall to the second sidewall.

13. The cold storage unit of claim 8, wherein the rack body includes a plurality of apertures cut from each of the rear wall and the first and second sidewalls.

14. The cold storage unit of claim 8, wherein the cold storage unit includes a tank with a storage space and an opening at a top end of the storage space, and wherein the handle further comprises:
an upper end configured to be positioned adjacent the opening when the storage rack is located within the storage space;
a lower end coupled to the rack body; and
an elongate intermediate portion extending between the upper end and the lower end,
wherein the upper end and the intermediate portion define a circular cross section and the lower end defines a flattened generally rectangular cross section such that the lower end is spot welded to the rack body.

15. A method of manufacturing a storage rack for holding storage boxes within a cold storage unit, comprising:
providing a flat sheet sized to define a rack body having a rear wall and first and second sidewalls;
punching a plurality of first lips from the flat sheet at the first sidewall and bending the first lips generally perpendicular to the flat sheet;
punching a plurality of second lips from the flat sheet at the second sidewall and bending the second lips generally perpendicular to the flat sheet;
bending the flat sheet to form a rack body with the first and second sidewalls extending from the rear wall such that the plurality of first lips and the plurality of second lips extend towards one another and are spaced from each other; and
coupling a handle to the rack body,
wherein the first and second lips on the rack body collectively define a plurality of shelves in the storage rack.

16. The method of claim 15, wherein the flat sheet defining the rack body also includes a top wall and a bottom wall, and the method further comprises:
bending the top and bottom walls and coupling the top and bottom walls to each of the first and second sidewalls.

17. The method of claim 15, further comprising:
stamping a plurality of apertures into the flat sheet at the rear wall and at the first and second sidewalls.

18. The method of claim 15, further comprising:
engaging a rack reinforcement plate with the first and second lips of one of the plurality of shelves,

19. The method of claim 18, further comprising:
positioning the rack reinforcement plate to extend from the first sidewall to the second sidewall.

20. The method of claim 18, wherein coupling the rack reinforcement plate to the first and second lips further comprises:
spot welding the rack reinforcement plate to the first and second lips of the one shelf.

21. The method of claim 15, wherein coupling the handle to the rack body further comprises:
spot welding the handle to the rack body.
